(19) United States
(12) Patent Application Publication
(10) Pub. No.: US 2026/0340494 A1
(43) Pub. Date: Oct. 29, 2026

(54) SYSTEMS AND METHODS FOR FINE-TUNING A MACHINE LEARNING MODEL FOR USE IN MANAGING REPORTED SERVICE PROBLEMS

(71) Applicant: TEACHERS INSURANCE AND ANNUITY ASSOCIATION OF AMERICA, New York, NY (US)

(72) Inventors: Niyatkumar Parikh, Pune (IN); Amritha Somabalan, Thane (IN); Jagruti Yawalkar, Burhanpur (IN); Arun Arumugam, Chennai (IN); Shafiq N. Kassam, Lewisville, TX (US); Ajit I. Naidu, Wyckoff, NJ (US)

(21) Appl. No.: 19/191,363

(22) Filed: Apr. 28, 2025

(51) Int. Cl. G06N 20/00

(52) U.S. Cl. CPC G06N 20/00

(57) ABSTRACT

A system may receive incident data that documents a reported service problem and convert the incident data to an input set of vector embeddings. The system may execute a support group identifying machine learning (ML) model with the input set of vector embeddings to generate a support group identifier. The system may compare the input set of vector embeddings to solution vector embeddings generated from historical service problem solutions to determine whether a probable solution to the reported service problem is present in the historical service problem solutions. The system may in response to determining that the probable solution is present, transmit data documenting how to implement the probable solution. The system may in response to determining that that the probable solution is not present, connect a first user device to a support system device for a support group indicated by the support group identifier.

### TECHNICAL FIELD

The present disclosure generally relates to computing systems for managing and resolving reported service problems, and more particularly, to systems and methods for fine-tuning a machine learning model for use in managing reported service problems.

### BACKGROUND

Information technology, computer related, or other services provided by an entity to customers, employees, contractors, etc. often encounter disruptions, outages, breakdowns, or other similar problems. To handle the resolution of these problems the entities employ or contract with personnel that process and seek to resolve reported service problems. To manage the multiplicity of possible problems that may require support, the entities divide the support personnel into different support groups with expertise related to different possible problems. However, given the large number of possible problems triaging the issues faced by users and identifying the correct support group can be challenging. Furthermore, assignment to the incorrect support group can delay resolution by requiring series of transitions between different groups. Additionally, entities maintain historical records of prior solutions and support group assignments, but lack the technical expertise to covert these resources into an automated support tool that can process newly reported service problems by identifying probable solutions among the historical data and assign the service problem to a correct support group for further processing and assistance when no probable solution is identified or a probable solution fails to resolve the problem.

### SUMMARY

In some aspects, the techniques described herein relate to a computer system including: one or more processors; and one or more non-transitory, computer-readable media storing instructions that, when executed by the one or more processors, cause the computer system to: receive, from a first user device, incident data that documents a reported service problem; convert the incident data to an input set of vector embeddings; execute a support group identifying machine learning (ML) model with the input set of vector embeddings as an input to generate a support group identifier for the incident data, wherein: the support group identifier indicates one of a plurality of support groups that the support group identifying ML model determines to be most relevant to the reported service problem based on processing of the input set of vector embeddings, the support group identifying ML model is fine-tuned from a pretrained base ML model based on training vector embeddings generated from a plurality of historical service problem cases and associated ground truth labels, and the associated ground truth labels indicate which of the plurality of support groups attended to the associated historical service problem case; compare the input set of vector embeddings to solution vector embeddings generated from a plurality of historical service problem solutions to determine whether a probable solution to the reported service problem is present in the plurality of historical service problem solutions; in response to determining that that the probable solution is present, transmit data documenting how to implement the probable solution to the first user device for display thereon; and in response to determining that that the probable solution is not present, connect the first user device to a support system device associated with the one of the plurality of support groups indicated by the support group identifier.

In some aspects, the techniques described herein relate to a computer implemented method for processing incident data to respond to a reported service problem, the method including: receiving, by one or more processors, incident data that documents a reported service problem from a first user device; converting, by the one or more processors, the incident data to an input set of vector embeddings; executing, by the one or more processors, a support group identifying machine learning (ML) model with the input set of vector embeddings as an input to generate a support group identifier for the incident data, wherein: the support group identifier indicates one of a plurality of support groups that the support group identifying ML model determines to be most relevant to the reported service problem based on processing of the input set of vector embeddings, the support group identifying ML model is fine-tuned from a pretrained base ML model based on training vector embeddings generated from a plurality of historical service problem cases and associated ground truth labels, and the associated ground truth labels indicate which of the plurality of support groups attended to the associated historical service problem case; comparing, by the one or more processors, the input set of vector embeddings to solution vector embeddings generated from a plurality of historical service problem solutions to determine whether a probable solution to the reported service problem is present in the plurality of historical service problem solutions; in response to determining that the probable solution is present, transmitting, by the one or more processors, data documenting how to implement the probable solution to the first user device for display thereon; and in response to determining that that the probable solution is not present, connecting, by the one or more processors, the first user device to a support system device associated with the one of the plurality of support groups indicated by the support group identifier.

In some aspects, the techniques described herein relate to a tangible, non-transitory computer-readable medium storing instructions, that, when executed by one or more processors of a computer system, cause the computer system to: receive, from a first user device, incident data that documents a reported service problem; convert the incident data to an input set of vector embeddings; execute a support group identifying machine learning (ML) model with the input set of vector embeddings as an input to generate a support group identifier for the incident data, wherein: the support group identifier indicates one of a plurality of support groups that the support group identifying ML model determines to be most relevant to the reported service problem based on processing of the input set of vector embeddings, the support group identifying ML model is fine-tuned from a pretrained base ML model based on training vector embeddings generated from a plurality of historical service problem cases and associated ground truth labels, and the associated ground truth labels indicate which of the plurality of support groups attended to the associated historical service problem case; compare the input set of vector embeddings to solution vector embeddings generated from a plurality of historical service problem solutions to determine whether a probable solution to the reported service problem is present in the plurality of historical service problem solutions; in response to determining that that the probable solution is present, transmit data documenting how to implement the probable solution to the first user device for display thereon; and in response to determining that that the probable solution is not present, connect the first user device to a support system device associated with the one of the plurality of support groups indicated by the support group identifier.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing environment in which various embodiments of the present disclosure can be implemented.

FIG. 2A depicts a schematic diagram of an example process for executing a support group identifying ML model in accordance with disclosed embodiments.

FIG. 2B depicts a schematic diagram of an example process for generating training vector embeddings in accordance with disclosed embodiments.

FIG. 2C depicts a schematic diagram of an example process for generating solution vector embeddings in accordance with disclosed embodiments.

FIG. 3 depicts a flow diagram of an example computer-implemented method for processing incident data to respond to a reported service problem.

FIG. 4 depicts a schematic diagram of an example process for fine-tuning a base ML model into a support group identifying ML model in accordance with disclosed embodiments.

FIG. 5 depicts a flow diagram of an example computer-implemented method for fine-tuning a base ML model into a support group identifying ML model in accordance with disclosed embodiments.

FIG. 6 depicts a flow diagram of another example computer-implemented method for processing incident data to respond to a reported service problem.

### DETAILED DESCRIPTION

The evolving landscape of information technology and customer service provides entities with daunting challenges of efficiently managing and resolving a myriad of service problems reported by users. Traditional approaches involve manual triage and assignment of issues to support groups, which is fraught with delays and inaccuracies due to misassignments and the sheer volume of potential issues. This inefficiency strains resources and negatively impacts user satisfaction. The disclosed computing system introduces a transformative solution leveraging machine learning (ML) technologies to automate and refine the process of service problem resolution. By harnessing the power of a fine-tuned support group identifying ML model, the systems and methods described herein enhance the accuracy and speed of problem resolution, to improve overall service quality and user experience.

The computing systems and methods described herein employ an ML model that is fine-tuned from a pretrained base model using historical service problem cases and associated ground truth labels. This fine-tuning process enables the model to accurately identify the most relevant support group for a given reported service problem, based on an analysis of input vector embeddings generated from the incident data. This approach streamlines the assignment process but also leverages historical data to identify probable solutions, which reduces the need for direct support intervention and accelerates problem resolution. Furthermore, the ability of the systems and methods to compare input vector embeddings with solution vector embeddings from historical service problem solutions allows for the identification of the probable solutions and provides a direct path to resolution for common or previously encountered issues.

Moreover, the computing system architecture described herein facilitates continuous improvement and customization of the ML model through a model training interface component. This component allows for fine-tuning of the model based on user inputs, enabling entities to adapt the system to their specific needs and evolving service problem landscapes. By providing a mechanism for entities to leverage their historical service problem data and expertise in a dynamic and automated fashion, the system represents a significant technical advancement over traditional manual triage and support group assignment processes. In essence, the disclosed computing systems and methods offer entities a powerful tool to enhance efficiency, accuracy, and user satisfaction through the application of advanced ML techniques and a user-centric design.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, the techniques described herein may be readily applied in any suitable field for any suitable purpose.

### EXAMPLE COMPUTING ENVIRONMENT

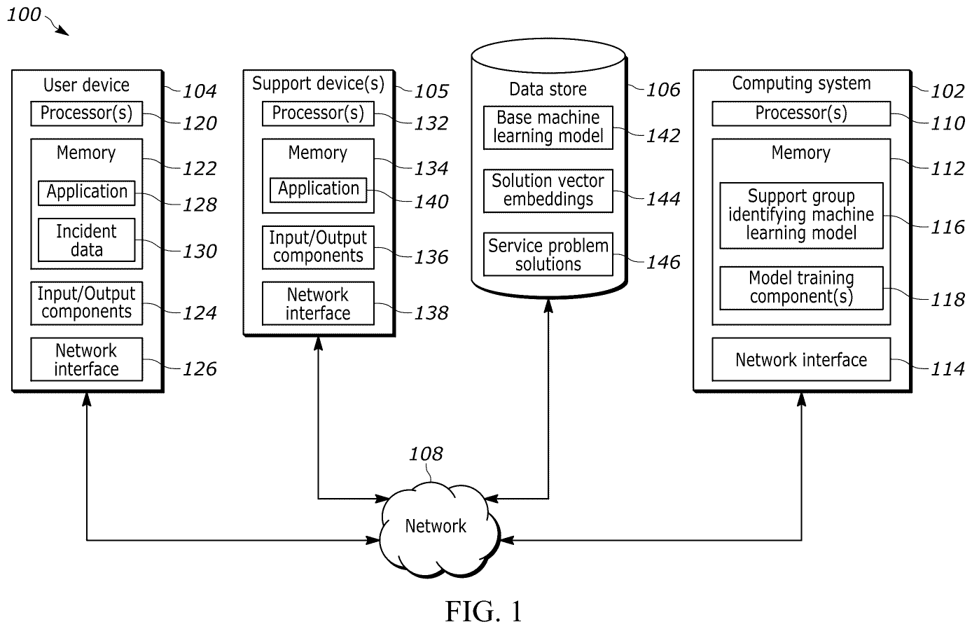

FIG. 1 depicts an example computing environment 100 in which various embodiments of the present disclosure may be implemented. Generally, the example computing environment 100 includes a computing system 102, a user device 104, support devices 105, and a data store 106, some or all of which are communicatively coupled via a network 108.

Generally, the user device 104 is associated with a user or other entity who may be seeking help to manage a specific service problem or configure a support group identifying ML model used by the computing system 102 to manage and process reported service problems. The computing system 102 may include a single server, or multiple servers that are co-located and/or remotely distributed, for example. In some embodiments, the computing system 102 provides data visualization services via an on premises platform a cloud platform (e.g., Amazon Web Services (AWS)®, Microsoft Azure®, or Google Cloud®). The computing system 102 includes one or more processors 110, memory 112, and a network interface 114.

The processor(s) 110 may include any suitable number of processors and/or processor types. In some examples, the processor(s) 110 include one or more central processing units (CPUs), one or more graphics processing units (GPUs), one or more tensor processing units (TPUs), one or more field-programmable gate arrays (FPGAs), one or more application-specific integrated circuits (ASICs), and/or the like. Generally, the processor(s) 110 comprise hardware configured to execute instructions (e.g., processor-executable code/instructions) stored in the memory 112.

The memory 112 may include any suitable memory type(s), including one or more volatile memories (e.g., dynamic and/or static random-access memory (RAM)) and/or non-volatile memories (e.g., read-only memory (ROM), erasable programmable ROM (EPROM), electrically EROM (EEROM), NAND flash, and/or solid state drive(s) (SSD(s))), all or any of which are examples of non-transitory computer-readable media. In some examples, the memory 112 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 112 stores the processor-executable instructions of a support group identifying ML model 116 and one or more model training components 118 that are used to train or fine-tune the support group identifying ML model 116 as described herein.

In some embodiments, the memory 112 may store more, fewer, and/or different components, than what is depicted in FIG. 1. In some embodiments, for example, some or all of the components that FIG. 1 shows as being stored in memory 112 are instead stored remotely, and are remotely accessed/used by the computing system 102. For example, the computing system 102 may remotely access the functionality of the support group identifying ML model 116 and the model training components 118 (or just access the support group identifying ML model 116, etc.) via an on premises platform or a cloud service provided by another entity and computing system.

The network interface 114 includes one or more hardware and/or software components that are generally configured to enable the computing system 102 to communicate, via the network 108, with other components and/or devices of the computing environment 100, such as the user device 104, the support devices 105, and the data store 106. To this end, the network interface 114 includes hardware and/or software that operates in accordance with at least one communication protocol of the network 108.

The network 108 includes one or more wired and/or wireless communication networks, such as a cellular network (e.g., 5G®, 4G LTE®, 3G®), a Wi-Fi® network (i.e., an IEEE 802.11 standards network), a microwave access network (e.g., WiMAX®), and/or any other suitable wide area network (WAN), local area network (LAN), personal area network (PAN), etc. As just one example, the network 108 may include both a wireless LAN such as a Wi-Fi® network and a WAN such as the Internet. In some embodiments, the network 108 includes multiple, entirely distinct/parallel networks (e.g., one or more networks for communications between computing system 102 and user device 104, and one or more separate networks for communications between computing system 102 and data store 106 or the support devices 105, etc.).

The user device 104 may be a desktop computer, a laptop computer, a tablet device, a mobile device, a wearable device (e.g., augmented or virtual reality glasses/headsets), or any other suitable computing device. The user device 104 includes one or more processors 120, memory 122, one or more input/output (I/O) components 124, and a network interface 126. In general the user device 104 is a device associated with a user of a service, platform, etc. associated with the entity that operates the computing system 102. The user may include a customer, employee, contractor, etc. that utilizes the service, platform, etc.

The processor(s) 120 may include any suitable number of processors and/or processor types. In some examples, the processor(s) 120 include one or more CPUs, one or more GPUs, one or more TPUs, one or more FPGAs, one or more ASICs, and/or the like. Generally, the processor(s) 120 comprise hardware configured to execute instructions (e.g., processor-executable code/instructions) stored in the memory 122. The memory 122 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 122 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 122 stores the processor-executable instructions of an application 128, which may be, for example, a web browser application or a dedicated application (e.g., a data visualization application offered/provided by an entity associated with computing system 102). Furthermore, the memory 122 may store incident data 130 that is used to categorize and/or assist the computing system 102 in resolving the reported service problem. In general, the incident data 130 may include text describing the reported service problem, log data from the user device 104 related to the reported service problem, images showing features of the reported service problem, etc. The reported service problem may include an information technology (IT) service problem, a user account issue, or other similar service problems that may arise in relation to computer, employee, or customer services offered by an entity associated with the computing system 102.

The I/O component(s) 124 include hardware and/or software that generally enables a user of user device 104 to interact with the user device 104. The I/O component(s) 124 may include one or more input components that enable a user of user device 104 to enter inputs to the user device 104 (e.g., a keyboard, a microphone, etc.), one or more output components that enable the user to perceive outputs generated by the user device 104 (e.g., a monitor/display, a speaker, a haptic feedback component, etc.), and/or one or more integrated I/O components (e.g., a touchscreen). The I/O component(s) 124 may use any suitable technology or technologies, such as LED, OLED, or LCD display technology, for example. While FIG. 1 shows user device 104 as a single component communicating (via network 108) with the computing system 102, in some implementations the components of user device 104 shown in FIG. 1 are instead divided among two or more client/user-side devices.

The network interface 126 includes one or more hardware and/or software components that are generally configured to enable the user device 104 to communicate, via the network 108, with other components and/or devices of the computing environment 100, such as the computing system 102, the support devices 105, or the data store 106. To this end, the network interface 126 includes hardware and/or software that operates in accordance with at least one communication protocol of the network 108.

The support devices 105, like the user device 104, may be a desktop computer, a laptop computer, a tablet device, a mobile device, a wearable device (e.g., augmented or virtual reality glasses/headsets), or any other suitable computing device. The support devices 105 may each include one or more processors 132, memory 134, one or more input/output (I/O) components 136, and a network interface 138. In general, the support devices 105 may include one or more devices that are associated with different support groups operated by the entity associated with computing system 102. These different support groups may include groups with expertise related to different types of problems that the user device 104 may report to the computing system 102 for resolution and assistance.

The processor(s) 132 may include any suitable number of processors and/or processor types. In some examples, the processor(s) 132 include one or more CPUs, one or more GPUs, one or more TPUs, one or more FPGAs, one or more ASICs, and/or the like. Generally, the processor(s) 132 comprise hardware configured to execute instructions (e.g., processor-executable code/instructions) stored in the memory 134. The memory 134 may include any suitable memory type(s), including one or more volatile memories (e.g., dynamic and/or static RAM) and/or non-volatile memories (e.g., ROM, EPROM, EEROM, NAND flash, and/or SSD(s)), all or any of which are examples of non-transitory computer-readable media. In some examples, the memory 134 stores one or more of: an operating system; one or more software components (e.g., firmware, application(s), binary, source code, executable instructions, machine-learned model(s)); transient data and/or code loaded and/or operated on by one or more software component(s); and/or other suitable components/data). In the example computing environment 100, the memory 134 stores the processor-executable instructions of an application 140, which may be, for example, a web browser application or a dedicated application (e.g., a data visualization application offered/provided by an entity associated with computing system 102). In some embodiments, the application 140 may include screen sharing functionalist to enable a user of the support devices 105 to connect to and provide support on the user device 104.

The I/O component(s) 136 include hardware and/or software that generally enables a user of support devices 105 to interact with the support devices 105. The I/O component(s) 136 may include one or more input components that enable a user of support devices 105 to enter inputs to the support devices 105 (e.g., a keyboard, a microphone, etc.), one or more output components that enable the user to perceive outputs generated by the support devices 105 (e.g., a monitor/display, a speaker, a haptic feedback component, etc.), and/or one or more integrated I/O components (e.g., a touchscreen). The I/O component(s) 136 may use any suitable technology or technologies, such as LED, OLED, or LCD display technology, for example. While FIG. 1 shows support devices 105 as a single component communicating (via network 108) with the computing system 102, in some implementations the components of support devices 105 shown in FIG. 1 are instead divided among two or more client/user-side devices.

The network interface 138 includes one or more hardware and/or software components that are generally configured to enable the support devices 105 to communicate, via the network 108, with other components and/or devices of the computing environment 100, such as the computing system 102, the user device 104, or the data store 106. To this end, the network interface 138 includes hardware and/or software that operates in accordance with at least one communication protocol of the network 108.

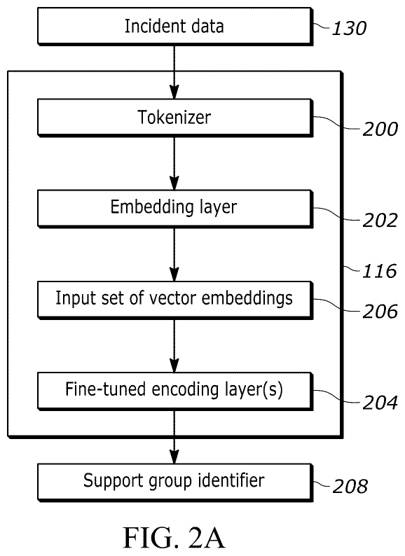

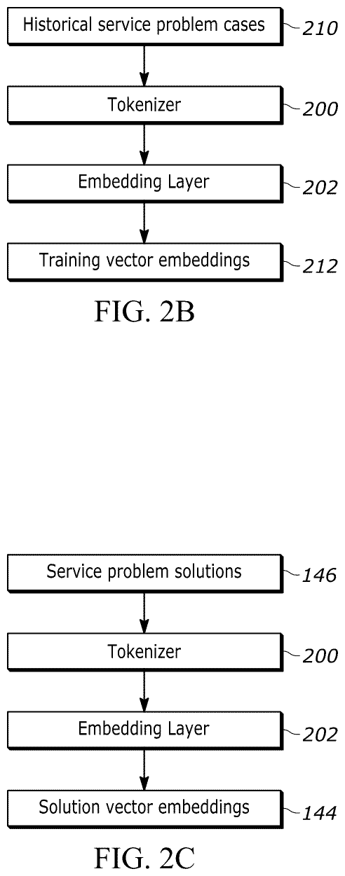

The data store 106 may be implemented as a database, data lake, memory, and/or other digital storage medium known in the art. Accordingly, the data store 106 may be a file system data store, an object-based data store, or other type of data store utilized in the art. Depending on the embodiment, the data store 106 may be implemented locally at the computing system 102, externally at an external data storage service, or a combination thereof. The computing system 102, via the network interface 114, may be in wired or wireless communication with the external data storage service. As described in more detail below, the data store 106 may store data that the computing system 102 uses to process the incident data 130 and/or to fine-tune the support group identifying ML model 116. In particular, the data store 106 may store a base ML model 142, solution vector embeddings 144, and service problem solutions 146, which are described in more detail below in connection with FIGS. 2A-5.

The support group identifying ML model 116 is fine-tuned variant of the base ML model 142 that is configured to output a support group identifier 208 (see FIG. 2A) for the incident data 130. In some embodiments, the computing system 102 may employ model training interface components 118 to fine-tune the base ML model 142 into the support group identifying ML model 116 as described in more detail below. However, it should be appreciated that in some embodiments the ML model 116 may be trained entirely from scratch to include the features attributed to the base ML model 142.

The ML models described herein may comprise generative machine-learned model component(s), such as a transformer-based machine-learned model (e.g., a large-language model (LLM), an embedding model, a diffusion model, and/or the like), and may additionally or alternatively comprise other machine-learned model component(s), such as neural network(s), decision tree(s), and/or the like. In some examples, the ML models are trained to use text as input and to generate text or, in other embodiments, may be a multimodal LLM that operates upon and/or generates text and also other types of content (e.g., text, images, audio, etc.). The ML models may receive a text prompt (referred to herein at times as simply a “prompt”) as an input, process the text prompt, and output text content responsive to the text prompt. The ML models may additionally or alternatively include a deep neural network and may perform various natural language processing tasks to understand a text query/prompt and generate a response to the text query/prompt, e.g., as part of a pre-processing operation and/or a post-processing operation. For example, in a pre-processing operation a neural network and/or another transformer-based machine-learned model may be trained to augment the original prompt to add sufficient context, which may be based on processing inputs determined from user and/or provider query responses, subsequent user and/or provider feedback, and/or the like, that is determined to be associated with the prompt. In a post-processing operation, the neural network and/or another transformer-based machine-learned model may be trained to review and alter, as necessary, an output of the transformer-based machine-learned model to be suitable for use by the ML models.

The functionality, operation, and tuning of the support group identifying ML model 116 are described in further detail below in connection with FIGS. 2A-5, according to some embodiments.

### EXAMPLE PROCESS FOR MANAGING A REPORTED SERVICE PROBLEM

FIG. 2A depicts a schematic diagram of an example process for executing the support group identifying ML model 16 to manage a service problem reported by the user device 104. Furthermore, as shown in FIG. 2A the support group identifying ML model 116 may have a transformer-based model architecture that comprises a tokenizer layer 200, an embedding layer 202, and fine-tuned encoding layers 204. The tokenizer layer 200 tokenizes the incident data 130 into sub-word level tokens using a tokenizing process such as byte pair encoding, WordPiece, etc. and the embedding layer 202 generate an input set of vector embeddings 206 based on the tokenized incident data 130. In some embodiments, the embedding layer 202 encodes positional relationships of the tokens generated from the incident data 130 into the set of vector embeddings 206. The fine-tuned encoding layers 204 process the set of vector embeddings 206 to generate the support group identifier 208. In particular, the fine-tuned encoding layers 204 may incorporate parameter values for self-attention and/or cross-attention mechanisms, and/or neural network(s) (e.g., feedforward layer(s)), recurrent layer(s), aggregation layer(s) (e.g., using softmax, matrix multiplication, and/or other aggregation techniques), and/or the like.

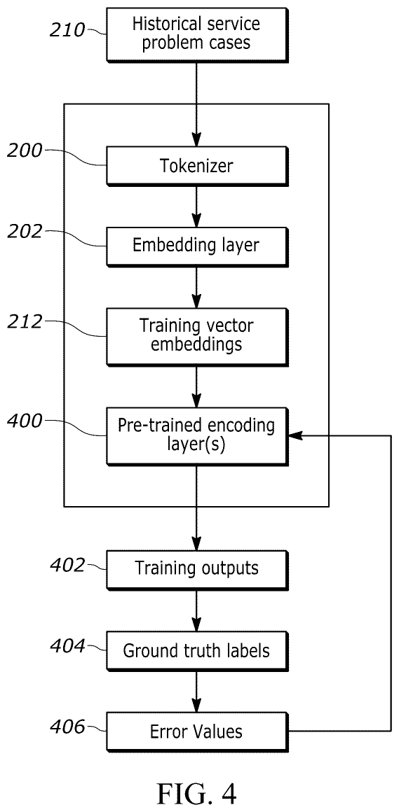

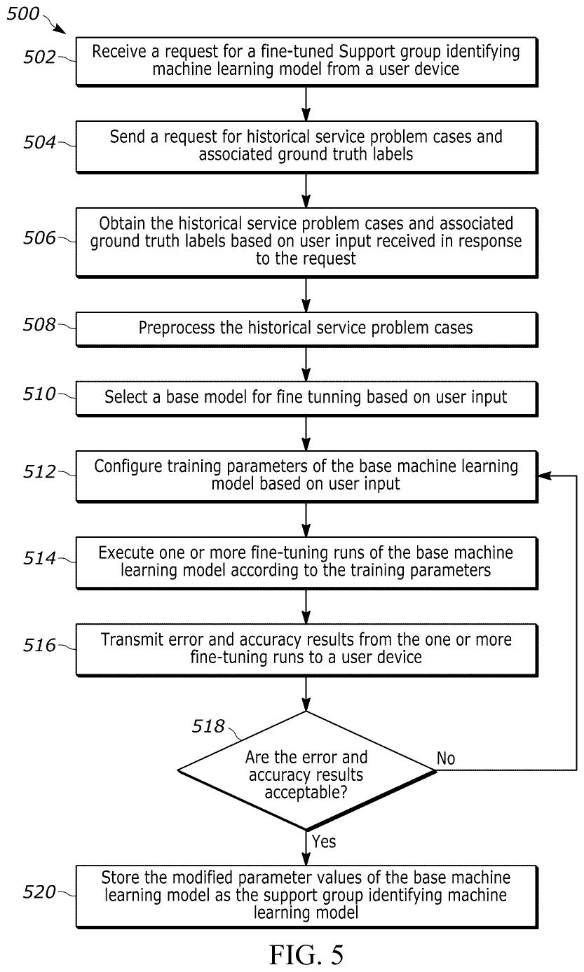

The parameter values of the fine-tuned encoding layers 204 may be fine-tuned from pretrained parameter values of the base ML model 142 to output the support group identifier 208. In particular, as shown in FIG. 2B, the tokenizer layer 200 and the embedding layer 202 may convert historical service problem cases 210 into training vector embeddings 212 used to fine-tune the base ML model 142. The fine-tuning process is described in more detail below in connection with FIGS. 4 and 5.

As shown in FIG. 2C, the tokenizer layer 200 and the embedding layer 202 may also generate the solution vector embeddings 144 from the service problem solutions 146. In general, the service problem solutions 146 may include text, image or other data documenting historical solutions to particular problems historically encountered by users of the service provided by the entity associated with the computing system 102. As described in more detail below, the computing system 102 may use the solution vector embeddings 144 to identify when there is a probable solution to the reported service problem contained within the service problem solutions 146, so that the computing system 102 may avoid having to connect the user device 104 to one of the support devices 105 for assistance in resolving the reported service problem. In some embodiments, the service problem solutions 146 may be a subsample or portion of the historical service problem cases 210 and the solution vector embeddings 144 may be extracted from the training vector embeddings 212.

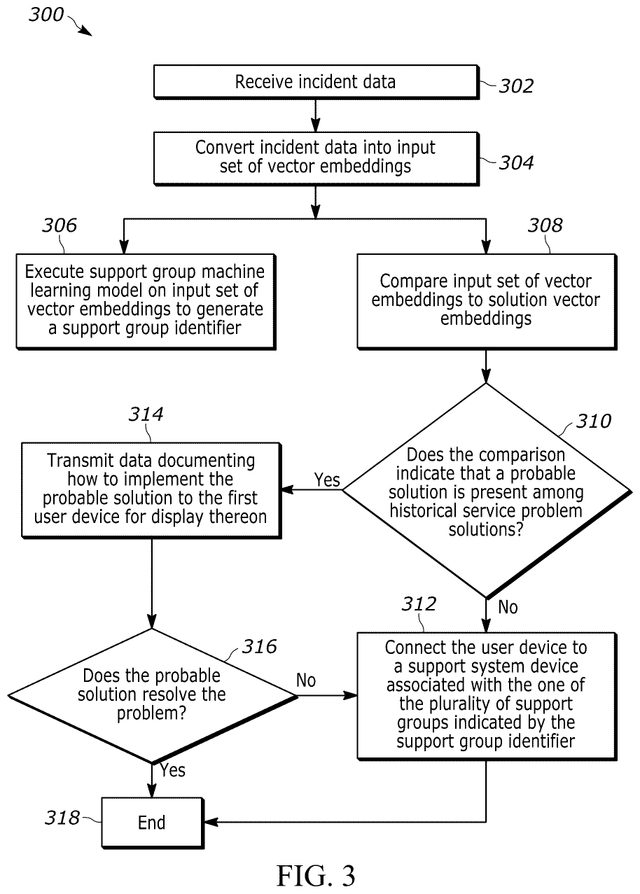

FIG. 3 depicts a flow diagram of an example computer-implemented method 300 for processing the incident data 130 to respond to the reported service problem. The computer-implemented method 300 may be implemented by processor-executable instructions stored in the memory 112 when executed by processor(s) 110, for example.

At operation 302, the computer-implemented method 300 may include the computing system 102 receiving the incident data 130 from the user device 104. In some embodiments, the computing system 102 may receive the incident data 130 as part of an automated support interface facilitated by the computing system 102 in connection with the application 128. For example, a user of the user device 104 may access the automated support interface using the application 128 where an automated chatbot system of the computing system 102 converses with the user (via text, image, and/or audio) to compile the incident data 130. In some embodiments, the automated chatbot system may request that the user of the user device 104 upload some or all of the incident data 130 to the computing system 102, Furthermore, the automated chatbot system may include an LLM or similar machine learning based system operated directly by the computing system 102 or in conjunction with another external computing system.

At operation 304, the computer-implemented method 300 may include the computing system 102 converting the incident data 130 into the input set of vector embeddings 206. In particular, the computer-implemented method 300 may include the computing system 102 passing the incident data 130 through the tokenizer layer 200 and embedding layer 202 of the support group identifying ML model 116 as shown and described in connection with FIG. 2A.

At operation 306, the computer-implemented method 300 may include the computing system 102 executing the support group identifying ML model 116 (e.g., the fine-tuned encoding layers 204) on the set of vector embeddings 206 to generate the support group identifier 208. The support group identifier 208 indicates one of a plurality of support groups maintained by the entity associated with the computing system 102 (e.g., the different support group associated with the support devices 105). The support group identifier 208 indicates the group that the support group identifying ML model 116, based on processing of the input set of vector embeddings 206, determines to be the most relevant group to process and rectify the reported service problem.

At operations 308, the computer-implemented method 300 may include the computing system 102 comparing the input set of vector embeddings 206 to the solution vector embeddings 144. In some embodiments, the computing system 102 may determine cosine similarity values between the input set of vector embeddings 206 and the solution vector embeddings 144. It should be appreciated that the computing system 102 may utilize other processes known in art for comparing the similarity of the input set of vector embeddings 206 and the solution vector embeddings 144 and/or for comparing the incident data 130 and the service problem solutions 146 directly. Example alternative methods may include but are not limited to Euclidean Distance, Jaccard Similarity, Pearson Correlation Coefficient, Manhattan Distance, Hamming Distance, Levenshtein Distance, Mahalanobis Distance, and Spearman's Rank Correlation processes. In some embodiments, the computing system 102 may retrieve the solution vector embeddings 144 from the data store 106 to perform the operations 308. Furthermore, in some embodiments, the solution vector embeddings 144 may be grouped according to which of the support groups provided the associated ones of the service problem solutions 146 from which the solution vector embeddings 144 are generated. In these embodiments, the computing system 102 may retrieve a subset of the solution vector embeddings 144 based on the support group identifier 208. In this way, the computing system 102 may limit the data used in the comparison and increased the efficiency of the processor(s) 110.

At operations 310, the computer-implemented method 300 may include the computing system 102 determine whether results of the comparison from operation 308 indicate that a probable solution is present among service problem solutions 146. In some embodiments, the computing system 102 determines that the probable solution is present when the cosine similarity value (or similarity value from another comparison method) for a most similar solution vector embedding (or set of vector embeddings associated with a single solution) exceeds a preconfigured threshold (e.g., 60, 70, 80, 90, etc. percent similarity).

At operation 312, in response to determining that the probable solution is not present, the computer-implemented method 300 may include the computing system 102 connecting the user device 104 to one of the support system devices 105 that is associated with the one of the plurality of support groups indicated by the support group identifier 208. In some embodiments, the computing system 102 may connect the user device 105 to one of the support system devices 105 by transmitting a notification to the support device 105 regarding the reported service problem and opening a network connection between the user device 104 and one of the support devices 105 in response to acknowledgment of the notification by one of the support devices 105. For example, the computing system 102 may transmit an email, text, push notification etc. to each or a subset (e.g., the support devices 105 for currently logged on/or available support personnel) of the support devices 105 associated with the indicated support group.

At operation 314, in response to determining that the probable solution is present, the computer-implemented method 300 may include the computing system 102 transmitting data documenting how to implement the probable solution (e.g., relevant portions of the service problem solutions 146) to the user device 104 for display thereon (e.g., as part of the chat interface facilitated by the application 128). The documentary data may include text, images, audio, video, etc. that instruct the user of the user device 104 on how to implement the probable solution. In some embodiments, the computing system 102 may transmit data on any of the service problem solutions 146 for which the cosine similarity value or other similarity metric exceeds the preconfigured threshold. In some embodiments, the data on these alternative possible solutions may be transmitted to the user device 104 after receiving further user input from the user device 104 that the initial probable solution failed to rectify the reported service problem.

Furthermore, at operation 316, the computer-implemented method 300 may include the computing system 102 determining whether the probable solution or solutions resolved the reported service problem. For example, the computing system 102 may receive user input indicating that the solution was resolves or that the user was otherwise not satisfied with the probable solution. When the probable solution or solutions do not resolve the reported service problem, the computer-implemented method 300 may include the computing system 102 connecting the user device 104 to one of the support system devices 105 in the manner described above with respect to operation 312.

At operation 318, the computer-implemented method 300 may end or otherwise terminate following operation 312 or when the computing system 102 determines, at operation 316 that the probable solution or solutions resolved the reported service problem.

It is to be understood that the operations of computer-implemented method 300 may be performed in any suitable order (and/or in parallel), and/or may include fewer, additional, or different operations, in various embodiments. For example, in some embodiments, the computer-implemented method 300 may include the computing system 102 refraining from performing the operation 306 until the computing system 102 determines that there is no probable solution present in the service problem solutions 146 and/or receives the user input indicating that one or more of the probable solutions failed to rectify the reported service problem.

### EXAMPLE MODEL FINE-TUNING PROCESS

FIG. 4 depicts a schematic diagram of an example process for fine-tuning the base ML model 142 into the support group identifying ML model 116. As shown in FIG. 4, the base ML model 142 includes the tokenizer layer 200 and the embedding layer 202 and a pre-trained encoding layer or layers 400. In general, the base ML model 142 may be a general-purpose model (e.g., trained on a wide array of publicly available datasets such as web pages, documents, etc., available via the Internet) such as a generative pre-trained transformer (GPT) 3.5, bi-directional encoder representations from transformers (BERT), or may be a domain-specific model (e.g., trained and/or fine-tuned on custom and/or proprietary datasets), such as a general purpose LLM trained using datasets of queries, responses, and user and/or provider feedback.

As described above in connection with FIG. 2B, the tokenizer layer 200 and the embedding layer 202 may convert historical service problem cases 210 into training vector embeddings 212. The computing system 102 then processes the training vector embeddings 212 through the layers 400 to generate training outputs 402 that are compared to ground truth labels 404 for the historical service problem cases 210 to generate error values 406. The computing system 102 may then update the various parameter values of the pre-trained layers 400 based on the error values 406 using backpropagation techniques known in the art. This process of generating the training outputs 402 and updating the parameter values based on the error values 406 may constitute a fine-tuning run of the base ML model 142 as used herein. In general, the fine-tuning runs refine the base ML model 142 to classify images, text, objects, etc. of the historical service problem cases 210 into a specific support group.

FIG. 5 depicts a flow diagram of an example computer-implemented method 500 for fine-tuning the base ML model 142 into the support group identifying ML model 116. The computer-implemented method 300 may be implemented by processor-executable instructions stored in the memory 112 when executed by processor(s) 110, for example. In particular, the fine-tuning operation may be performed by the one or more model training components 118 of FIG. 1.

Furthermore, the computing system 102 (e, g., the one or more model training components 118) may operate a web portal, user interface framework, application interface, etc. to enable a user device to request and initiate creation of the support group identifying ML model 116. The user device may include one of the support devices 105, the user device 104, or any other similar device with appropriate access privileges to direct the computing system 102 to create the support group identifying ML model 116. The computing system 102 may solicit and the user device may proved a series of user inputs that direct the fine-tuning process used to create the support group identifying ML model 116. In this way the computing system 102 may provide a streamlined and automated process to generate a customized ML model for use in processing reported service problems in the manner described herein.

Furthermore, this streamlined process enables an entity to generate the custom ML model without needing to directly program the various fine-tunning operations described herein and understand the specific implementation details used when training and/or tuning an ML model. For example, the user of the computing system 102 and the one or more model training components 118 does not need to be versed in programming languages such as Python, Web frameworks such as Flask, and Libraries such as Scikit-learn, Keras, transformers, etc. used to build ML models. Instead the computing system 102 packages all these features in an accessible interface that may be utilized regardless of background technical understanding.

At operation 502, the computer-implemented method 500 may include the computing system 102 receiving a request for the fine-tuned support group identifying ML model 116 from a user device connected to the computing system 102 (e.g., connected via the network 108 and/or via a directly connected terminal). In particular, the request may be received as part of the user interface platform or framework managed by the computing system 102.

At operation 504, the computer-implemented method 500 may include the computing system 102 may send a request to the user device to upload or otherwise identify the historical service problem cases 210 and the ground truth labels 404.

At operation 506, the computer-implemented method 500 may include the computing system 102 obtaining the historical service problem cases 210 and associated ground truth labels 404 based on user input received in response to the request. For example, the computing system 102 may obtain the historical service problem cases 210 and ground truth labels 404 from the user device connected to the computing system 102 and/or from a data store (e.g., the data store 106) based on one or more location identifiers received as user input from the user device.

At operation 508, the computer-implemented method 500 may include the computing system 102 preprocessing the historical service problem cases 210. The preprocessing may include formatting, cleaning, or modifying the historical service problem cases 210 for use in the fine-tuning process. In particular, the preprocessing may remove a preconfigured set of stop words from the plurality of historical service problem cases 210 and/or split the plurality of historical service problem cases 210 into smaller sized chunks of text that are less than or equal to a context window size of the base ML model 142. In some embodiments, stop words include common text that is not likely to have predictive or explanatory value (e.g., “the,” “a,” “and,” etc.). In some embodiments, the computer-implemented method 500 may include the computing system 102 converting the historical service problem cases 210 into the training vector embeddings 212 following the operation 508.

At operation 510, the computer-implemented method 500 may include the computing system 102 selecting the base ML model 142 based on user input received from the user device. For example, the computing system 102 may host or store multiple different base models in the data store 106 or similar storage device that the user may select from to generate the support group identifying ML model 116. Additionally or alternatively, the computing system 102 may receive access credentials for or a copy of an additional third party model that may be fine-tuned into the support group identifying ML model 116.

At operation 512, the computer-implemented method 500 may include the computing system 102 configuring training parameters of the base ML model 142 based on further user input received from the user device connected to the computing system 102. The training parameters may include one or more of a learning rate of the base ML model 142, error settings, or a target loss rate. Furthermore, in some embodiments, the initial values of the learning parameters may be set to default values and adjusted to reflect generalized responses received by the computing system 102 as user input. For example, the user of the user device may send a text user inputs indicating general preferences for how the support group identifying ML model 116 should be fine-tuned and the computing system 102 may convert these generalized preferences into specific values to use as the training parameters. Example preferences may be to prioritize accuracy over training speed, to minimize error, etc.

At operation 514, the computer-implemented method 500 may include the computing system 102 executing one or more fine-tuning runs of the base ML model 142 according to the training parameters. In particular, the computing system 102 may generate the training vector embeddings 212 and modify the current parameter values of the pre-trained encoding layer(s) 400 as described above in connection with FIG. 4 until the error values 406 reach a predetermined threshold, the error values 406 have minimally changed from a previous fine-tuning run, and/or a preset number of fine-tuning runs have been executed.

At operation 516, the computer-implemented method 500 may include the computing system 102 transmitting error and accuracy results (e.g., the error values 406 or text descriptions thereof) from the one or more fine-tuning runs to the user device.

At operation 518, the computer-implemented method 500 may include the computing system 102 determining whether the error and accuracy results are acceptable.

At operation 520, the computer-implemented method 500 may include the computing system 102 storing the modified parameter values of the base ML model 142 (e.g., the modified parameter values of the pre-trained encoding layer(s) 400) as the support group identifying ML model 116 (e.g., fine-tuned encoding layers 204). In some embodiments, the computing system 102 may execute operation 520 in response to receiving user input accepting the error and accuracy results. When the error and accuracy results are rejected or otherwise not accepted, the computer-implemented method 500 may include the computing system 102 returning to operation 512 to reconfigure the training parameters and execute additional fine-tuning runs of the base ML model 142.

It is to be understood that the operations of computer-implemented method 500 may be performed in any suitable order (and/or in parallel), and/or may include fewer, additional, or different operations, in various embodiments.

### EXAMPLE COMPUTER IMPLEMENTED METHOD

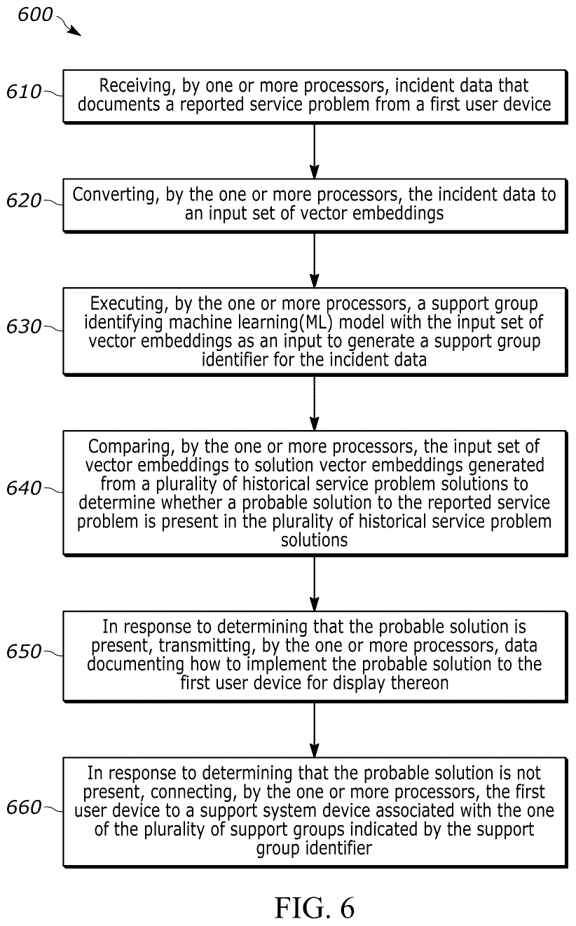

FIG. 6 is a flowchart of an example computer-implemented method 600 for processing incident data to respond to the reported service problem using a fine-tuned machine learning model. The computer-implemented method 600 may be implemented by processor-executable instructions stored in the memory 112 when executed by processor(s) 110, for example.

At operation 610, the computer-implemented method 600 includes receiving, by one or more processors (e.g., processor(s) 110), incident data (e.g., incident data 130) that documents a reported service problem from a first user device (e.g., user device 104). The incident data may include one or more of text describing the reported service problem, log data from the first user device related to the reported service problem, or images showing features of the reported service problem.

At operation 620, the computer-implemented method 600 includes converting, by the one or more processors, the incident data to an input set of vector embeddings (e.g., input set of vector embeddings 206).

At operation 630, the computer-implemented method 600 includes executing, by the one or more processors, a support group identifying machine learning (ML) model (e.g., support group identifying ML model 116) with the input set of vector embeddings as an input to generate a support group identifier (e.g., support group identifier 208) for the incident data. The support group identifier indicates one of a plurality of support groups that the support group identifying ML model determines to be most relevant to the reported service problem based on processing of the input set of vector embeddings. The support group identifying ML model is fine-tuned from a pretrained base ML model (e.g., base ML model 142) based on training vector embeddings (e.g., training vector embeddings 212) generated from a plurality of historical service problem cases (e.g., historical service problem cases 210) and associated ground truth labels (e.g., ground truth labels 404). The associated ground truth labels indicate which of the plurality of support groups attended to the associated historical service problem case.

At operation 640, the computer-implemented method 600 includes comparing, by the one or more processors, the input set of vector embeddings to solution vector embeddings (e.g., solution vector embeddings 144) generated from a plurality of historical service problem solutions (e.g., service problem solutions 146) to determine whether a probable solution to the reported service problem is present in the plurality of historical service problem solutions. In some embodiments, the solution vector embeddings are a sub-portion of the training vector embeddings. In some embodiments, comparing the input set of vector embeddings to the solution vector embeddings includes determining cosine similarity values between the input set of vector embeddings and the solution vector embeddings. In these embodiments, the computer-implemented method 600 includes determining that the probable solution is present when the cosine similarity value for a most similar solution vector embedding exceeds a preconfigured threshold and retrieving the data documenting how to implement the probable solution based on the most similar solution vector embedding. In some embodiments, the computer-implemented method 600 may include retrieving the solution vector embeddings from a data store (e.g., data store 106) based on the support group identifier.

At operation 650, the computer-implemented method 600 includes in response to determining that that the probable solution is present, transmitting, by the one or more processors, data documenting how to implement the probable solution to the first user device for display thereon.

At operation 660, the computer-implemented method 600 includes in response to determining that that the probable solution is not present, connecting, by the one or more processors, the first user device to a support system device (e.g., support devices 105) associated with the one of the plurality of support groups indicated by the support group identifier. In some embodiments, connecting the first user device to a support system device includes transmitting a notification to the support device regarding the reported service problem and opening a network connection between the first user device and the support device in response to acknowledgment of the notification by the support device.

In some embodiments, the computer-implemented method 600 may include receiving, from the first user device, user input indicating that the probable solution did not resolve the reported service problem and connecting the first user device to the support system device associated with the one of the plurality of support groups indicated by the support group identifier in response to receiving the user input.

In some embodiments, the support group identifying ML model includes an embedding layer. The computer-implemented method 600 may include converting, via the embedding layer, the incident data to an input set of vector embeddings, generating, via the embedding layer, the training vector embeddings from the plurality of historical service problem cases, and generating the embedding layer, the solution vector embeddings from the plurality of historical service problem solutions.

In some embodiments, the computer-implemented method 600 includes using a model training interface component to fine-tune the pretrained base ML model into the support group identifying ML model based on user inputs received from a second user device. The model training interface component may fine-tune the pretrained base ML model by: obtaining the plurality of historical service problem cases and associated ground truth labels based on the user inputs; select the base ML model based on the user inputs; configuring training parameters of the base ML model based on the user inputs; converting the plurality of historical service problem cases into the training vector embeddings; executing one or more fine-tuning runs of the base ML model according to the training parameters and using the training vector embeddings as inputs to modify current parameter values of the base ML model; transmitting error and accuracy results from the one or more fine-tuning runs to the second user device; and storing the modified parameter values of the base ML model as the support group identifying ML model responsive to acceptance of the error and accuracy results received in the user inputs. The model training interface component may also preprocess the plurality of historical service problem cases to remove a preconfigured set of stop words from the plurality of historical service problem cases and/or to split the plurality of historical service problem cases into smaller sized chunks of text that are less than or equal to a context window size of the base ML model. The training parameters may include one or more of a learning rate of the base ML model, error settings, or a target loss rate. In some embodiments, the model training interface component obtains the plurality of historical service problem cases and associated ground truth labels form the second user device as one or more of the user inputs. Additionally or alternatively, the model training interface component obtains the plurality of historical service problem cases and associated ground truth labels form a data store based on one or more location identifiers received as part of the user inputs.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer system comprising:
one or more processors; and
one or more non-transitory, computer-readable media storing instructions that, when executed by the one or more processors, cause the computer system to:
receive, from a first user device, incident data that documents a reported service problem;
convert the incident data to an input set of vector embeddings;
execute a support group identifying machine learning (ML) model with the input set of vector embeddings as an input to generate a support group identifier for the incident data, wherein:
the support group identifier indicates one of a plurality of support groups that the support group identifying ML model determines to be most relevant to the reported service problem based on processing of the input set of vector embeddings,
the support group identifying ML model is fine-tuned from a pretrained base ML model based on training vector embeddings generated from a plurality of historical service problem cases and associated ground truth labels, and
the associated ground truth labels indicate which of the plurality of support groups attended to the associated historical service problem case;
compare the input set of vector embeddings to solution vector embeddings generated from a plurality of historical service problem solutions to determine whether a probable solution to the reported service problem is present in the plurality of historical service problem solutions;
in response to determining that the probable solution is present, transmit data documenting how to implement the probable solution to the first user device for display thereon; and
in response to determining that the probable solution is not present, connect the first user device to a support system device associated with the one of the plurality of support groups indicated by the support group identifier.

2. The computer system of claim 1 wherein:
to compare the input set of vector embeddings to the solution vector embeddings, the instructions, when executed by the one or more processors, cause the computer system to determine cosine similarity values between the input set of vector embeddings and the solution vector embeddings;
the system determines that the probable solution is present when the cosine similarity value for a most similar solution vector embedding exceeds a preconfigured threshold; and
the instructions, when executed by the one or more processors, cause the computer system to retrieve the data documenting how to implement the probable solution based on the most similar solution vector embedding.

3. The computer system of claim 1 wherein to compare the input set of vector embeddings to solution vector embeddings, the instructions, when executed by the one or more processors, cause the computer system to:
retrieve the solution vector embeddings from a data store based on the support group identifier.

4. The computer system of claim 1 wherein the support group identifying ML model includes an embedding layer, and wherein the embedding layer is configured to:
convert the incident data to an input set of vector embeddings;
generate the training vector embeddings from the plurality of historical service problem cases; and
generate the solution vector embeddings from the plurality of historical service problem solutions.

5. The computer system of claim 1 wherein the solution vector embeddings are a sub-portion of the training vector embeddings.

6. The computer system of claim 1 further comprising a model training interface component configured to fine-tune the pretrained base ML model into the support group identifying ML model based on user inputs received from a second user device.

7. The computer system of claim 6 wherein to fine-tune the pretrained base ML model into the support group identifying ML model, the model training interface component is configured to:
obtain the plurality of historical service problem cases and associated ground truth labels based on the user inputs;
select the base ML model based on the user inputs;
configure training parameters of the base ML model based on the user inputs;
convert the plurality of historical service problem cases into the training vector embeddings;
execute one or more fine-tuning runs of the base ML model according to the training parameters and using the training vector embeddings as inputs to modify current parameter values of the base ML model;
transmit error and accuracy results from the one or more fine-tuning runs to the second user device; and
store the modified parameter values of the base ML model as the support group identifying ML model responsive to acceptance of the error and accuracy results received in the user inputs.

8. The computer system of claim 7 wherein the model training interface component is further configured to:
preprocess the plurality of historical service problem cases to remove a preconfigured set of stop words from the plurality of historical service problem cases and/or to split the plurality of historical service problem cases into smaller sized chunks of text that are less than or equal to a context window size of the base ML model.

9. The computer system of claim 7 wherein the training parameters include one or more of a learning rate of the base ML model, error settings, or a target loss rate.

10. The computer system of claim 7 wherein the model training interface component obtains the plurality of historical service problem cases and associated ground truth labels form the second user device as one or more of the user inputs.

11. The computer system of claim 7 wherein the model training interface component obtains the plurality of historical service problem cases and associated ground truth labels form a data store based on one or more location identifiers received as part of the user inputs.

12. The computer system of claim 1 wherein the incident data includes one or more of text describing the reported service problem, log data from the first user device related to the reported service problem, or images showing features of the reported service problem.

13. The computer system of claim 1 wherein to connect the first user device to a support system device, the instructions, when executed by the one or more processors, cause the computer system to:
transmit a notification to the support device regarding the reported service problem; and
open a network connection between the first user device and the support device in response to acknowledgment of the notification by the support device.

14. The computer system of claim 1 wherein the instructions when executed by the one or more processors, further cause the computer system to:
receive, from the first user device, user input indicating that the probable solution did not resolve the reported service problem; and
connect the first user device to the support system device associated with the one of the plurality of support groups indicated by the support group identifier in response to receiving the user input.

15. A computer implemented method for processing incident data to respond to a reported service problem, the method comprising:
receiving, by one or more processors, incident data that documents a reported service problem from a first user device;
converting, by the one or more processors, the incident data to an input set of vector embeddings;
executing, by the one or more processors, a support group identifying machine learning (ML) model with the input set of vector embeddings as an input to generate a support group identifier for the incident data, wherein:
the support group identifier indicates one of a plurality of support groups that the support group identifying ML model determines to be most relevant to the reported service problem based on processing of the input set of vector embeddings,
the support group identifying ML model is fine-tuned from a pretrained base ML model based on training vector embeddings generated from a plurality of historical service problem cases and associated ground truth labels, and
the associated ground truth labels indicate which of the plurality of support groups attended to the associated historical service problem case;
comparing, by the one or more processors, the input set of vector embeddings to solution vector embeddings generated from a plurality of historical service problem solutions to determine whether a probable solution to the reported service problem is present in the plurality of historical service problem solutions;
in response to determining that the probable solution is present, transmitting, by the one or more processors, data documenting how to implement the probable solution to the first user device for display thereon; and
in response to determining that the probable solution is not present, connecting, by the one or more processors, the first user device to a support system device associated with the one of the plurality of support groups indicated by the support group identifier.

16. The computer implemented method of claim 15 wherein comparing the input set of vector embeddings to the solution vector embeddings includes determining, by the one or more processors, cosine similarity values between the input set of vector embeddings and the solution vector embeddings and further comprising:
determining, by the one or more processors, that the probable solution is present when the cosine similarity value for a most similar solution vector embedding exceeds a preconfigured threshold; and
retrieving the data documenting how to implement the probable solution based on the most similar solution vector embedding.

17. The computer implemented method of claim 15 further comprising fine-tuning, by a model training interface component, the pretrained base ML model into the support group identifying ML model by:
obtaining the plurality of historical service problem cases and associated ground truth labels based on user inputs received from a second user device;
selecting the base ML model based on the user inputs;
configuring training parameters of the base ML model based on the user inputs;
converting the plurality of historical service problem cases into the training vector embeddings;
executing one or more fine-tuning runs of the base ML model according to the training parameters and using the training vector embeddings as inputs to modify current parameter values of the base ML model;
transmitting error and accuracy results from the one or more fine-tuning runs to the second user device; and
storing the modified parameter values of the base ML model as the support group identifying ML model responsive to acceptance of the error and accuracy results received in the user inputs.

18. The computer implemented method of claim 17 further comprising:
preprocessing the plurality of historical service problem cases to remove a preconfigured set of stop words from the plurality of historical service problem cases and/or to split the plurality of historical service problem cases into smaller sized chunks of text that are less than or equal to a context window size of the base ML model.

19. A tangible, non-transitory computer-readable medium storing instructions, that, when executed by one or more processors of a computer system, cause the computer system to:
receive, from a first user device, incident data that documents a reported service problem;
convert the incident data to an input set of vector embeddings;
execute a support group identifying machine learning (ML) model with the input set of vector embeddings as an input to generate a support group identifier for the incident data, wherein:
the support group identifier indicates one of a plurality of support groups that the support group identifying ML model determines to be most relevant to the reported service problem based on processing of the input set of vector embeddings,
the support group identifying ML model is fine-tuned from a pretrained base ML model based on training vector embeddings generated from a plurality of historical service problem cases and associated ground truth labels, and
the associated ground truth labels indicate which of the plurality of support groups attended to the associated historical service problem case;
compare the input set of vector embeddings to solution vector embeddings generated from a plurality of historical service problem solutions to determine whether a probable solution to the reported service problem is present in the plurality of historical service problem solutions;
in response to determining that the probable solution is present, transmit data documenting how to implement the probable solution to the first user device for display thereon; and
in response to determining that the probable solution is not present, connect the first user device to a support system device associated with the one of the plurality of support groups indicated by the support group identifier.

20. The tangible, non-transitory computer-readable medium of claim 19 wherein the instructions, when executed by one or more processors of the computer system, cause the computer system to fine-tune, by a model training interface component, the pretrained base ML model into the support group identifying ML model by:
obtaining the plurality of historical service problem cases and associated ground truth labels based on user inputs received from a second user device;
selecting the base ML model based on the user inputs;
configuring training parameters of the base ML model based on the user inputs;
converting the plurality of historical service problem cases into the training vector embeddings;
executing one or more fine-tuning runs of the base ML model according to the training parameters and using the training vector embeddings as inputs to modify current parameter values of the base ML model;
transmitting error and accuracy results from the one or more fine-tuning runs to the second user device; and
storing the modified parameter values of the base ML model as the support group identifying ML model responsive to acceptance of the error and accuracy results received in the user inputs.
